(19) United States
(12) Patent Application Publication
(10) Pub. No.: US 2005/0094491 A1
(43) Pub. Date: May 5, 2005

(54) Clock movement with moon dial

(76) Inventor: Michael Gerard Wallace, Grand Rapids, MI (US)

Correspondence Address: Warner Norcross & Judd LLP, 900 Fifth Third Center, 111 Lyon Street, N.W., Grand Rapids, MI, 49503-2487, US

(21) Appl. No.: 10/699,171

(22) Filed: Oct. 31, 2003

(51) Int. Cl. G04B 19/26; G04B 49/00

(52) U.S. Cl. 368/15

(57) ABSTRACT

A clock movement having a moon dial that includes symmetric teeth about its periphery. The movement also includes a driving gear with a pin that engages the teeth so that each rotation of the drive gear advances the moon disk. Because the moon dial teeth are symmetric, the moon dial can be rotated either forward or backward by moving the driving gear either forward or backward. The rotational support of the moon dial includes a wave washer to apply a small frictional force to prevent freewheeling.

### BACKGROUND OF THE INVENTION

The present invention relates to clock movements, and more particularly to clock movements including moon dials.

An example of the structure of a conventional clock movement with a moon dial is shown in FIG. 2 and generally designated 100. The moon dial is a disk 114 that has a saw-toothed periphery 116 with each tooth angled in the same direction. The visible face of the moon dial (not shown) includes two moons that show the different phases of the moon as the dial rotates. The moon dial 114 is driven by a gear 118 that is driven by the movement through a series of other gears 122. The drive gear 118 makes one revolution every twenty-four hours. A pin 120 extends from the underside of the drive gear 118, and the pin 120 engages the saw teeth 116 to drive the moon dial 114 one step or tooth for each revolution of the drive gear 118 (i.e. one tooth per day). A click spring 140 engages the saw-teeth 116 of the moon disk 114 in a ratchet arrangement. The spring provides pressure to prevent the disk 114 from freewheeling and to prevent the disk 114 from rotating backward. The click spring 140 also advances the disk 114 beyond the capability of the drive gear 118 and pin 120.

In the above-described clock 110, proper alignment of the pin 120, the saw teeth 116, and the click spring 140 is essential for proper operation. If a saw tooth 116 is out of position when the pin 120 rotates to engage it, the pin 120 and gear 118 may not provide an adequate force to properly advance the moon dial disk 114. If the click spring 140 applies excessive force on the moon dial disk 114, the click spring 140 may prevent the moon disk 114 from moving and, in severe cases, may halt the entire clock movement. If the click spring 140 is not properly adjusted to advance the disk 114 when driven by the drive gear 118 and pin 120, it may also prevent the moon disk 114 from moving and, in severe cases, may halt the entire clock movement.

### SUMMARY OF THE INVENTION

The aforementioned problems are overcome by the present invention providing a moon dial that can move both forward and backward, having a simplified construction, and having a reliable performance without synchronized fine adjustment of the moon dial, drive gear, pin, and click spring. In particular, the moon disk includes teeth having a generally symmetric profile so that the drive gear can move the moon disk forward or backward with each rotation of the drive gear.

In a specific embodiment, a rotational friction device is used in mounting the moon disk on the movement to prevent freewheeling of the disk. As disclosed, the friction device is a wave washer that applies consistent but small amount of friction to the moon disk to prevent over-rotation or freewheeling while still allowing the moon disk to be easily rotated.

The present invention has several advantages. First, the click spring of the prior art is eliminated, along with its aforementioned problems. Second, the moon dial can be set by rotating the hands of the clock either forward or backward. Third, since it is no longer necessary to properly synchronize and adjust multiple components to function harmoniously, it is significantly less likely that the moon dial feature will prevent the moon disk from moving or halt the entire clock movement.

These and other objects, advantages, and features of the invention will be more readily understood and appreciated by reference to the detailed description of the preferred embodiment and the drawings.

### BRIEF DESCRIPTION OF THE DRAWINGS

FIG. 1 is a front view of a clock having a movement in accordance with the present invention.

FIG. 2 is a rear view of a prior art moon dial clock movement.

FIG. 3 is a rear view of the clock dial of the present invention.

FIG. 4 is an enlarged rear view of the present invention.

FIG. 5 is a cross sectional view along line 5 in FIG. 4.

FIG. 6 is a cross sectional view along line 6 in FIG. 3.

### DETAILED DESCRIPTION OF THE PREFERRED EMBODIMENT

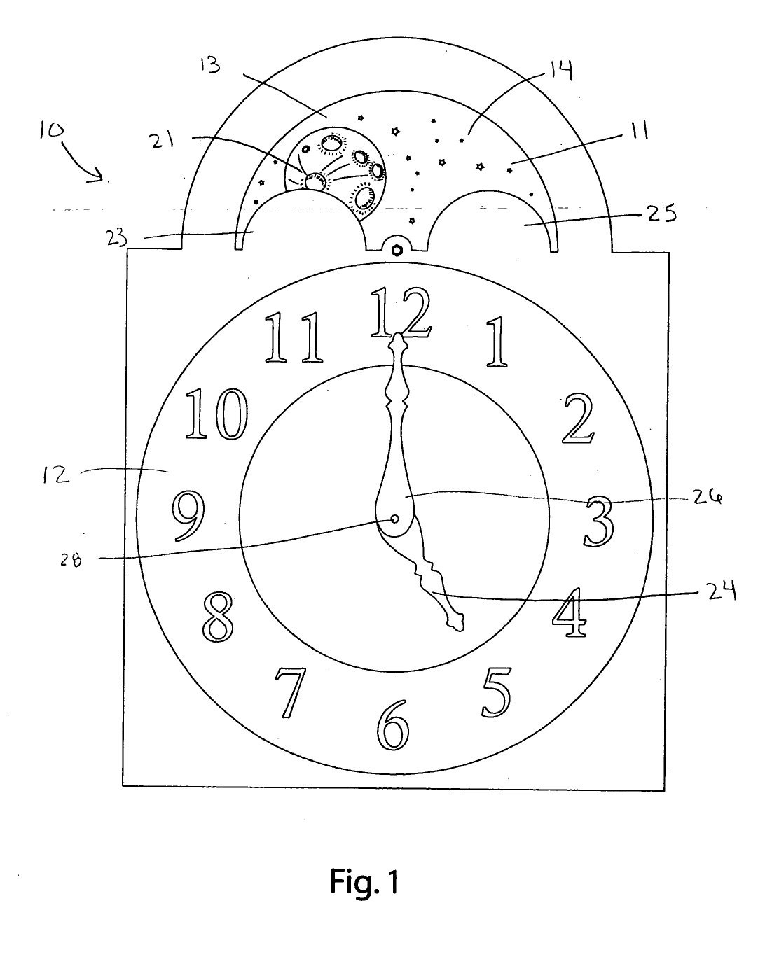

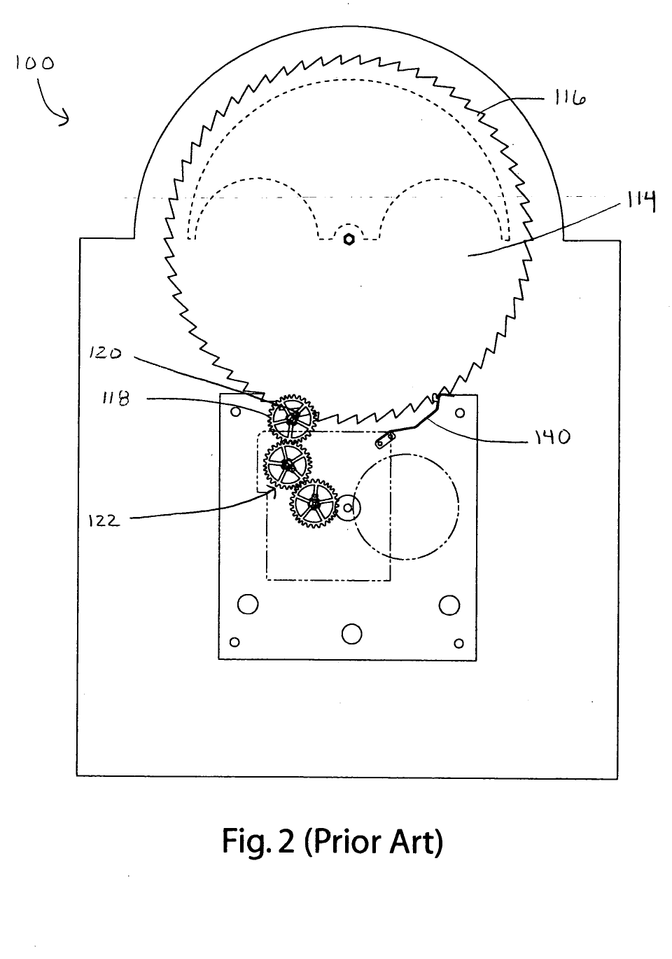

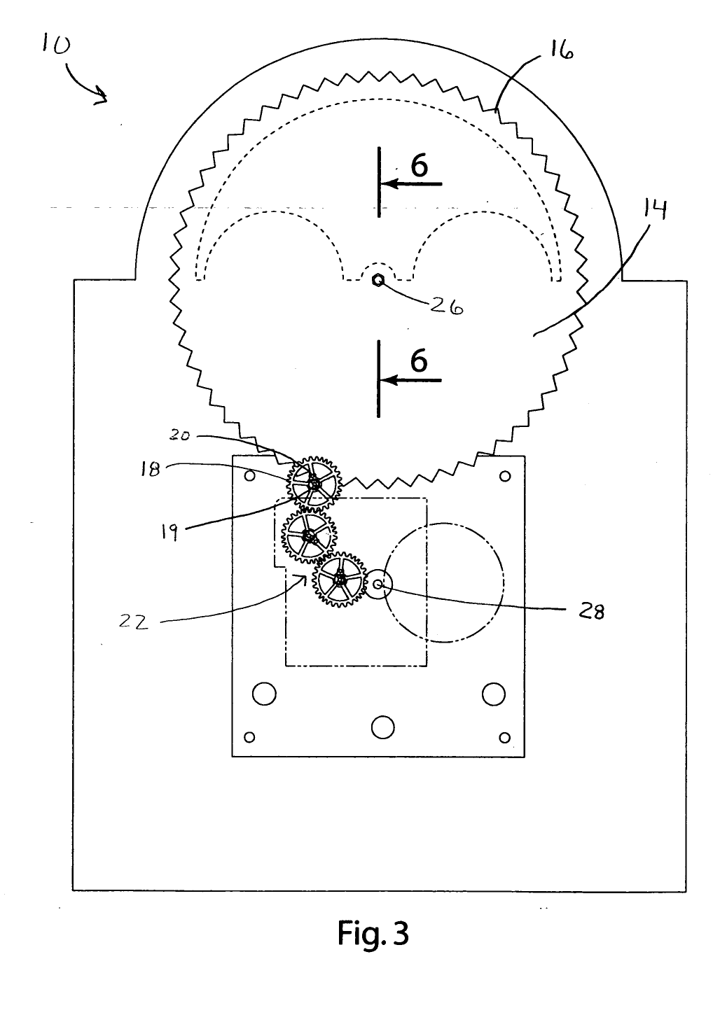

A clock dial including a moon dial mechanism in accordance with the preferred embodiment is shown in FIG. 1 and generally designated 10. The clock 10 generally includes conventional face 12 and a separate moon dial disk 14. Only a portion of the moon dial disk 14 is visible from a front view of the clock dial 10. As shown in FIG. 3, the moon dial disk 14 generally has a plurality of teeth 16 about the periphery, and a drive gear 18 that includes a pin 20 to engage the teeth 16. The drive gear 18 is integrated with a series of gears 22 such as those in a generally conventional clock dial, such that the drive gear 18 rotates once per twenty-four hour period.

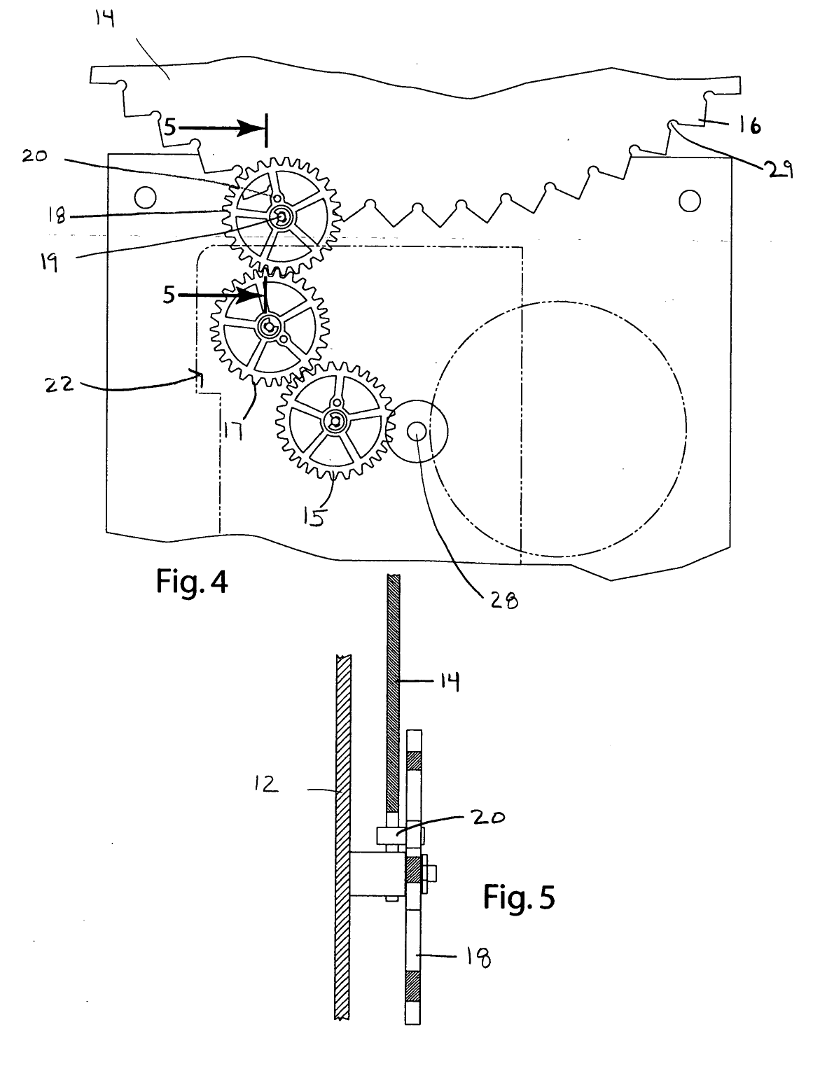

As shown in FIGS. 1 and 3, the clock dial is generally conventional. In the preferred embodiment, the clock dial 10 is adapted to be fit into a housing, such as a grandfather clock or the like. The clock dial 10 is shown in this configuration for purposes of description, but may also be sized or adapted for a variety of alternative arrangements. The clock dial 10 generally includes a face 12 with an hour hand 24 and a minute hand 26. The hands 24 and 26 are rotatable about an axis 28, and driven by conventional clock means. The axis 28 is linked, either directly or indirectly through conventional drive means, to a series of gears 22 including a drive gear 18 that engages the moon disk 14. As shown in FIG. 4, in a preferred embodiment, the series of gears 22 includes a first gear 15 in direct communication with a gear on the axis 28, a second gear 17 in communication with the first gear 15, and a drive gear 18 in communication with second gear 17. The gears 22 preferably have the same ratio and are driven such that they each make one revolution every twenty-four hour period.

The drive gear 18 is generally a standard gear, rotatable about an axis 19 parallel to the clock dial axis 28. The drive gear 18 also includes a pin 20 that engages the moon disk 14. The pin 20, shown in FIG. 5, preferably protrudes from the drive gear 18 in a direction perpendicular to the gear 18 and parallel with the axis 19, extending into the clock dial 10 towards the moon dial 14. The gear 18 is located relative to the moon disk 14 such that the pin 20 engages the teeth 16 of the moon disk 14 once for every revolution of the drive gear 18. The moon dial disk 14 is therefore incremented one tooth per day.

As shown in FIG. 3, the moon dial disk 14 is generally a circular metal sheet that is capable of rotation about an axis 26. As seen in FIG. 1, the disk 14 includes a display 11 on one surface 13 of the moon dial disk 14. The display 11 generally includes two depictions of the moon 21 (only one is shown) on opposing sides of the same surface 13 of the moon dial disk 14. Approximately one-half of the display 11 is visible from a front view of the clock dial 10, the other half covered behind the clock face 12 and a pair of semi-circular hemisphere projections 23 and 25 extending from the face 12. As the moon dial disk 14 rotates clockwise, a portion of one of the moons 21 becomes visible behind semi-circular projection 23 representing a waxing moon. Further rotation brings the moon 21 into full view (a full moon), until a portion of the moon 21 is covered by the second semi-circular projection 25, representing a waning moon.

Referring now to FIGS. 4 and 5, the moon dial disk 14 includes a plurality of teeth 16 about the periphery. The teeth 16 preferably have a symmetric tooth profile, and are spaced such that pin 20 engages one tooth 16 for each revolution of the drive gear 18. One revolution of the drive gear 18 in either direction increments the moon disk 14 one tooth 16. The most preferred tooth profile is shown in the enlarged view of the moon dial disk 14 in FIG. 4. In this preferred tooth profile each tooth 16 has a symmetrical “V” shape, and adjacent teeth are joined by a semi-circular notch 29.

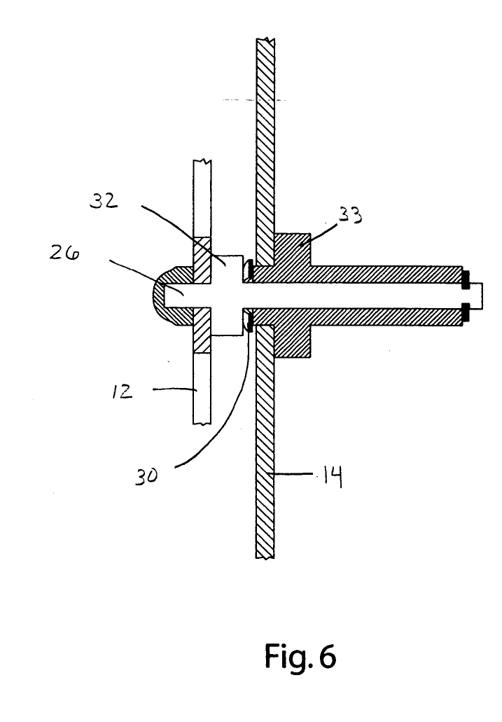

Referring now to FIG. 6, the axis 26 also includes a wave washer 30. The washer 30 is preferably disposed about axis 26 and held in consistent friction with the moon dial disk 14 by a conventional bushing method. The washer 30 preferably has a curved or convex shape such that when held between the bushing 33 on disk 14 and a post 32 the washer can flex slightly to provide a constant pressure to the disk 14 without binding the rotation of the disk 14. The washer 30 is shown in FIG. 6 such that the convex side faces the disk 14, but can be oriented in either direction so long as consistent friction is applied to the moon dial disk 14.

The above description is that of a preferred embodiment of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A clock dial comprising:
a rotatable moon dial have a perimeter and a plurality of identical teeth uniformly spaced about said perimeter, each of said teeth being generally symmetrical;
a rotatable driving gear having a pin extending therefrom, said pin positioned to engage one of said teeth with each rotation of said driving gear to rotatably advance said moon dial, each of said symmetrical teeth permitting said pin to move said moon dial either forward or backward depending on the direction of rotation of said driving gear.

2. The clock dial movement of claim 1 wherein said moon dial has an axis of rotation, and further comprising friction means for applying rotational friction to said moon dial, said friction means mounted on said axis.

3. The clock dial movement of claim 2 wherein said friction means comprises a wave washer engaging said moon dial.

4. The clock dial movement of claim 3 wherein said driving gear completes one revolution every twenty-four hours.

5. A clock dial movement device for advancing a moon dial comprising:
a drive disk, said drive disk in rotation actuated by the clock movement;
a pin protruding from said drive disk;
a moon disk having a plurality of generally symmetrical teeth, said pin engaging said teeth such that said moon disk increments one tooth per forward or backward revolution of said drive disk.

6. The clock of claim 5 wherein a wave washer maintains a consistent friction with said moon disk, preventing said disk from incrementing when not engaged by said pin.

7. The clock of claim 6 wherein said drive disk makes one revolution per 12 hours.

8. The clock of claim 7 wherein said clock has conventional hands and said disk may be incremented forward or backward by any manual or automatic rotation of said hands.

9. A mechanism for rotating a moon dial on a clock movement comprising:
a moon disk axis;
a moon disk rotatable on said moon disk axis, said moon disk including images of the moon on one surface, said moon disk including a plurality of teeth about the circumference of said moon disk, each of said teeth having a symmetric profile;
a friction device on said moon disk axis creating friction between said disk and said moon disk axis; and
a drive disk rotatable about a second axis, said drive disk including a pin extending from said drive disk, said pin periodically interfitting with said teeth on said moon disk, said pin incrementally rotating said moon disk forward or backward one tooth for each revolution of said drive disk.

10. The mechanism of claim 9 wherein said friction device is a wave washer.
